(19) United States
(12) Patent Application Publication
(10) Pub. No.: US 2009/0010300 A1
(43) Pub. Date: Jan. 8, 2009

(54) Electrode Robot For Adding Electrodes Having Threaded Connectors of Various Thread Pitches

(76) Inventor: Didier Potey, Lausanne (CH)

Correspondence Address: GrafTech International Holdings, Inc., 12900 Snow Road, Parma, OH, 44130, US

(21) Appl. No.: 12/114,291

(22) Filed: May 2, 2008

Related U.S. Application Data
(60) Provisional application No. 60/958,253, filed on Jul. 3, 2007.

(51) Int. Cl. H05B 7/14

(52) U.S. Cl. 373/92

(57) ABSTRACT

A device for adding graphite electrodes onto an electrode column is provided. This device, also known as an electrode robot, includes an engagement mechanism capable of being easily adapted to a plurality of thread pitches so that the device can add different electrodes having threaded connectors of different thread pitches.

### BACKGROUND

Graphite electrodes are used in the steel industry to melt the metals and other ingredients used to form steel in electrothermal furnaces, also known as Electric Arc Furnaces. The heat needed to melt metals is generated by passing current through one or a plurality of electrodes, usually three, and forming an arc between the electrodes and the metal. Electrical phase currents in excess of 50,000 amperes are often used.

The resulting high temperature melts the metals and other ingredients and also consumes the electrodes over time. Generally, the electrodes used in steel furnaces each consist of electrode columns consisting of a series of individual electrodes joined together to form a single column. In this way, as electrodes are depleted during the thermal process, replacement electrodes can be joined to the column to maintain a desired length of the column extending into the furnace.

Referring to FIG. 1, one example of a graphite electrode manufactured by UCAR Carbon Company Inc., now known as Grafrech International Holdings Inc., Parma, Ohio, USA, known as the AGX® electrode (also known as a pin electrode), is shown at 100 and 102. Electrode 100 is joined to another electrode 102, which is part of an electrode column (a portion of which is shown at 104a) via a pin 106, also referred to as a nipple, that functions to join the ends 100a and 102a of adjoining electrodes. Both electrodes 100 and 102 may include female threaded sections 108 at each end of the electrodes. The pin 106 can take the form of opposed male threaded sections, or tangs, 106a, with at least one end of the electrodes 100a comprising a female threaded section 108 capable of mating with the male threaded section 106a of the pin 106. Thus, when each of the opposing male threaded sections 106a of a pin 106 are threaded into female threaded sections 108 in the ends of two electrodes 100, 102, those electrodes become joined into an electrode column 104a. The thread pitch of these AGX® electrodes 100, and others, is typically 4 Threads per Inch (TPI).

Again, referring to FIG. 1, other graphite electrodes, available from the UCAR Carbon Company, 120 and 122, known as APOLLO™ electrodes (also known as a pinless electrode), are pinless and formed with a male threaded protrusion, or tang 124, machined into one end 120a and 122a, and a female threaded socket 126 machined into the other end 120b. These electrodes 120 and 122 can be joined by aligning the electrodes axially and threading the male tang 124 of one electrode into the threaded female socket 126 of a second electrode, to form an electrode column (a portion of which is shown at 104b). The threaded surfaces 124, 126 of these APOLLO™ electrodes and others, typically have thread pitches of 2 TPI.

The threaded surfaces of graphite electrodes (referred to generally hereinafter as electrode 130, as depicted in FIG. 3) are often formed of graphite or graphite in combination with other materials such as, but not limited to, reinforcing fibers. Furthermore, the electrodes 130 are large and heavy. Adequate precautions must be taken during addition of an electrode to an electrode column so as not to cause interference between the threads which can damage them. Damaging the threads can prevent an electrode from being added correctly to the column which may result in the costly electrode being scrapped or cause stress leading to cracking or failure resulting in an electrode or electrode column dropping onto the shop floor or into the electric arc furnace. Other issues regarding the addition of an electrode to an electrode column include safety concerns and minimizing furnace downtime associated with changing electrode columns.

Conventional electrode addition devices, also known as Electrode Robots, can only accommodate electrodes of a single thread pitch which limits their versatility and increases the cost of being able to handle/add electrodes with different thread pitches, since different devices are required.

### BRIEF DESCRIPTION

An embodiment disclosed herein includes a device for adding a graphite electrode to an electrode column. The electrode may include threaded connectors for connecting the electrode to the column. The device includes an adaptable engagement mechanism for adding different electrodes having threaded connectors for different thread pitches.

### BRIEF DESCRIPTION OF THE DRAWINGS

FIG. 1 is a block diagram illustrating different electrodes having threaded connectors of different thread pitches;

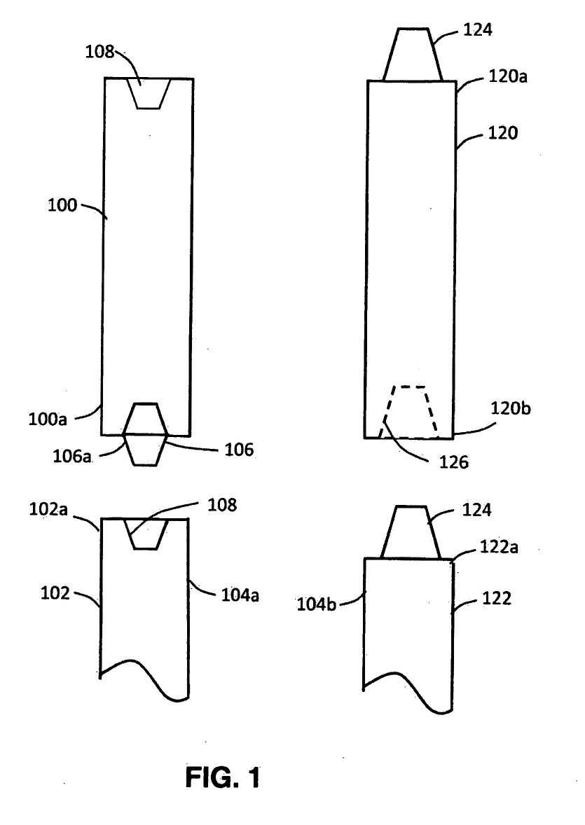

FIG. 2 is side view of an electrode robot in accordance with the invention;

FIG. 3 is a diagram of a portion of the electrode robot holding an electrode for addition to an electrode column;

FIG. 4 is a diagram of a portion of the electrode robot adding a first electrode having threaded connections of a first thread pitch; and

FIG. 5 is a diagram of a portion of electrode robot adding a second electrode having threaded connections of a second thread pitch different than the first thread pitch.

### DETAILED DESCRIPTION

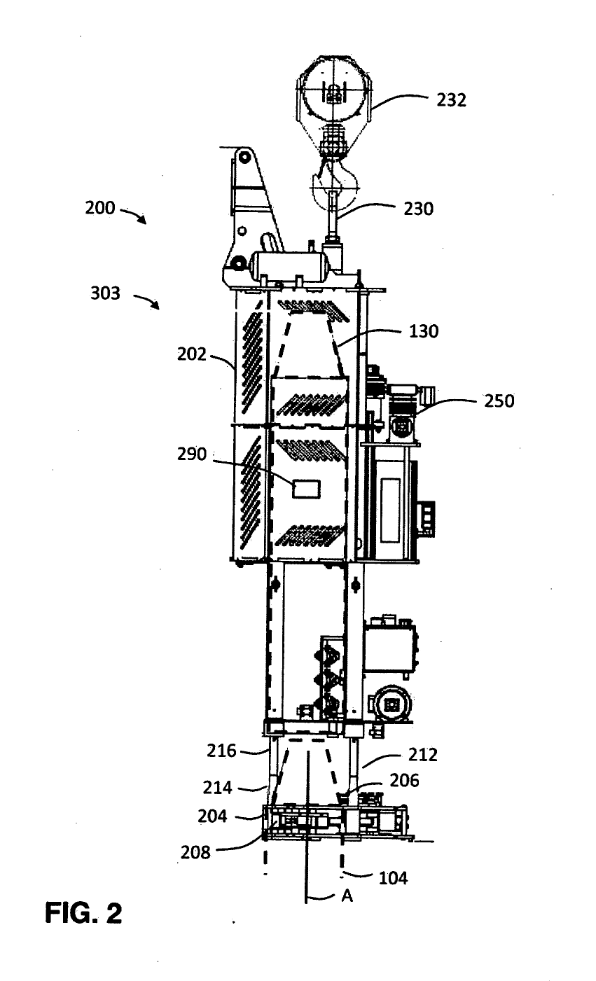

With reference to FIG. 2, an electrode addition device, commonly referred to as an electrode robot, for adding graphite electrodes (shown in phantom at 130) onto an electrode column (a portion of which is shown in phantom at 104) is shown generally at 200. The device 200 includes an upper portion 202 for gripping, rotating and lowering an electrode 130 for addition to a column 104, as described in further detail below.

The device 200 also includes a lower portion 204 having leveling knives 206 for aligning the device with the axis of the electrode column 104 shown as axis A. Preferably, device 200 includes two (2) or more leveling knives 206. The lower portion 204 also includes a gripping mechanism 208 for gripping the radially outer surface of the cylindrical electrode column 104 to prevent unwanted rotation of the device 200 relative to the column during the addition of the new electrode 130 and for aiding in the alignment of the new electrode with the column. The gripping mechanism 208 can be a three point clamp system, having three clamping members for engaging the electrode at three circumferentially spaced locations, though other clamping mechanisms can be used.

Furthermore, device 200 may optional include one or more sensors located on device 200 to determine when electrode 100 (or 120) comes within a predetermined distance of electrode column 104a (or 104b). The predetermined distance may be when electrode 100 comes in contact with column 104 or alternatively prior to electrode 100 contacting column 104 by a prescribed distance. In one embodiment, such sensor(s) may be located on lower portion 204 of device 200.

The device 200 can also include a mid portion 212 disposed between the upper portion 202 and the lower portion 204 and connecting them together. The mid portion 212 can include telescoping members 214 having lateral “give” enabling the device 200 to accommodate an electrode column 104 having an axis A that is not plumb with a lateral axis of device 200. The mid portion 212 can also include removable pins 216 which can be exchanged with other pins of various lengths to vary the distance between the upper portion 202 and the lower portion 204. In an alternate embodiment pins 216 may be welded to portion 204. In one particular embodiment, the length of pins 216 may correlate to the length of the tang of the electrode.

The device 200 may be used to add electrodes of different lengths between about 2000 mm and about 4000 mm, including commonly used electrodes having lengths between about 2900 mm and about 3400 mm, and in some embodiments up to about 3800 mm. Standard lengths and diameters of electrodes may be described in IEC standard 60239 which is incorporated herein by reference in its entirety. An embodiment disclosed herein includes a device 200 that can accommodate an electrode with a nominal length of greater than 2700 mm.

In an alternate embodiment, lower portion 204 may be connected to mid portion 212 through the use of a retractable chain link element instead of telescoping members 214. The retractable chain link element may be used to disengage lower portion 204 from portion 212 by any predesired distance. In a further embodiment portion 202 may be connected to portion 212 by a retractable chain link element.

The device 200 can also include a hook loop 230 for hanging the device from a crane 232 for moving the device and the electrode 130 into position over the electrode column 104 for addition. The device 200 can include an air compressor 250 for providing compressed air to remove debris, dust, or other accumulated material from the threads of the electrode 130 and/or electrode column 104.

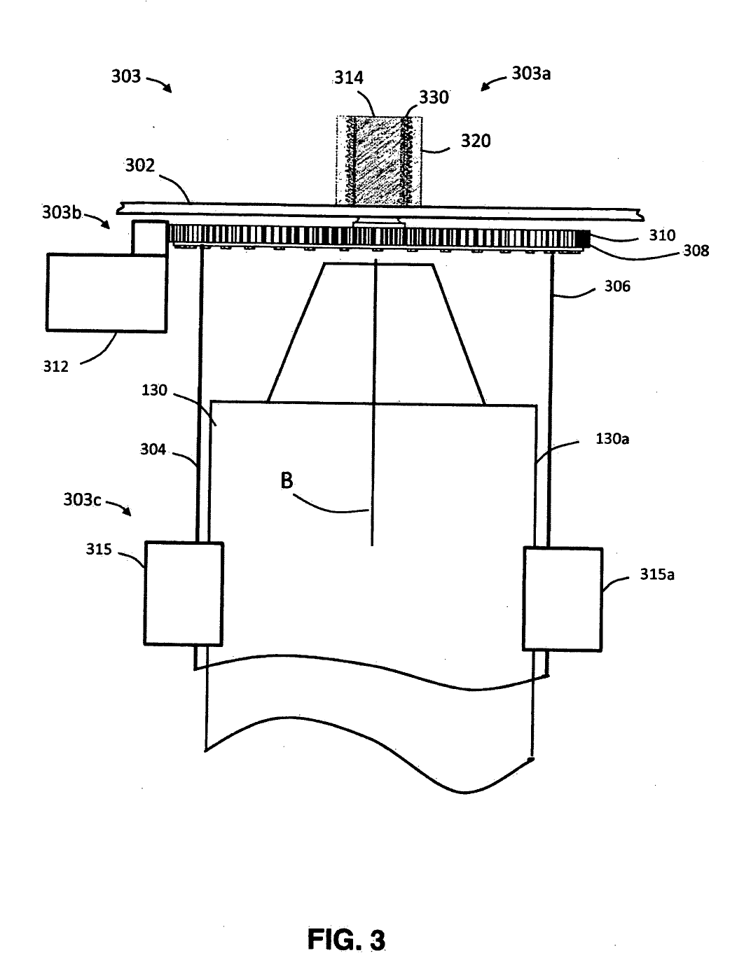

Referring now to FIG. 3, the device 200 includes a reference support surface 302 for supporting an engagement mechanism, shown generally at 303. The engagement mechanism 303 includes a lowering mechanism 303a for lowering the electrode 130 an amount commensurate with the thread pitch of the threaded connectors connecting the new electrode to the electrode column. The lowering mechanism 303a can be easily adapted to add different electrodes, such as for example electrodes 100 and 120, each having threaded connectors of different thread pitches, to their corresponding electrode columns 104a and 104b.

The engagement mechanism 303 can also include a rotating mechanism 303b for rotating the electrode 130 to screw the electrode to the electrode column 104. The engagement mechanism 303 can also include a gripping mechanism 303c for holding the electrode 130 during addition to enable the rotating mechanism 303b to rotate the electrode and/or the lowering mechanism 303a to lower the electrode for addition.

Rotating mechanism 303b may be located at positions other than as shown in FIG. 3. One example of such position may be mid way along the length of electrode drum 304.

As described in further detail below, the engagement mechanism can include threaded members cooperating at a first threaded interface having a first thread pitch and threaded members cooperating at a second threaded interface having a second thread pitch, different than the first thread pitch, for adding different electrodes having threaded connectors of different thread pitches. The engagement mechanism can also include a first retaining element removably connected to at least some of the threaded members for enabling movement of the engagement mechanism along the first threaded interface and preventing movement of the engagement mechanism along the second threaded interface. The engagement mechanism can further include a second retaining element removably connected to at least some of the threaded members for enabling movement of the engagement mechanism along the second threaded interface and preventing movement of the engagement mechanism along the first threaded interface.

In the example embodiment described herein, the reference support surface 302 and engagement mechanism 303 are located in the upper portion 202; though it should be appreciated that different adaptations achieving similar results can be contemplated.

The rotating mechanism 303b includes an electrode drum 304. The drum 304 includes an end 306 having a drum drive gear 308 fastened thereto. The drum drive gear 308 includes an external toothed portion 310 adapted to be driven by a motor 312 for rotating the drum 304 about an axis B. Preferably, drum 304 is sized to accommodate different electrodes having diameters of more than one size. Examples of typical sizes of electrodes which the device 200 may be able to accommodate for adding to an electrode column include 600 mm, 650 mm, 700 mm, and/or 750 mm.

The gripping mechanism 303c includes a clamp 315 having clamp members 315a for clamping the exterior surface 130a of the electrode 130. The clamp members 315a may penetrate the electrode surface 130a by several millimeters when clamped. Preferably, clamp 315 can grip electrodes of different diameters. Examples of typical sizes of electrode diameters which the clamp 315 may grip for adding electrodes to a column include 600 mm, 650 mm, 700 mm, and/or 750 mm.

The gripping mechanism 303c cooperates with the rotating mechanisms 303b to enable sufficient torque forces to be applied to the electrode 130 to rotate it relative to the electrode column 104 until the two are completely screwed together. In the example embodiment described herein, the clamp 315 is rotated with the drum 304; however it should be appreciated that other adaptations can be contemplated.

The device 200 can also include sensors (A.K.A. e.g., pressure switches) (290 in FIG. 2) for determining the amount of torque force that is applied to satisfactorily secure the new electrode 130 to the electrode column 104. A typical example of suitable torque for a 600 mm diameter electrode are from about 2700 foot-pounds (3660 N-m), though other suitable torque forces can be applied by the device 200.

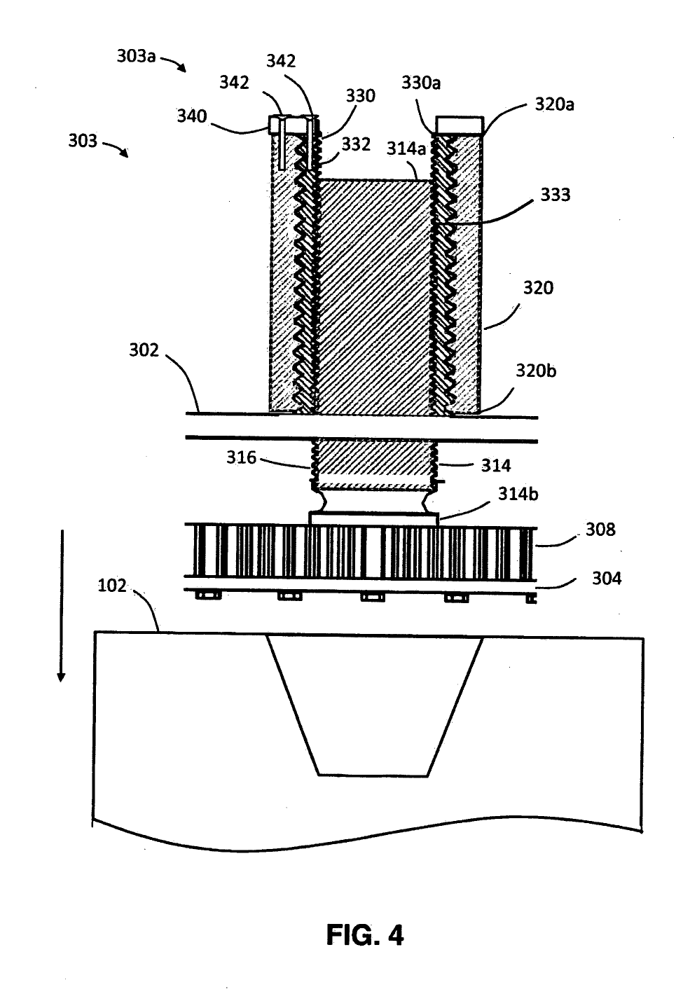

Referring now to FIG. 4, the lowering mechanism 303a includes a screw 314 having a first end 314a and an oppositely disposed second end 314b. The second end 314b is connected to the center of the drum gear 308 so that the screw and drum gear are coaxially aligned about an axis of rotation B (as shown in FIG. 3). The cylindrical screw 314 can be solid having a radially outer surface, as shown in this example embodiment. However it should be appreciated that the screw 314 can be hollow so as to form a hollow cylinder having a radially inner surface and a radially outer surface of any suitable diameters.

The lowering mechanism 303a cooperates with the rotating mechanism 303b to rotate and lower the electrode 130 an amount commensurate with the thread pitch of the electrode's threaded connectors. In the example embodiment described herein, the screw 314 and drum gear 308 are connected together for rotation about axis B such that rotation of the drum 304, via the drum gear 308, rotates the screw 314 at the same rate of rotation. However, it should be appreciated that other adaptations can be contemplated enabling the lowering mechanism 303a and a rotating mechanism to cooperate in a manner sufficient to add different electrodes having different pitch threads. Examples of suitable pitches may range from about two (2) to about eight (8) threads per inch.

The screw 314 includes a radially outer threaded surface 316 having a first thread pitch. In the example embodiment described herein, the first thread pitch is 4 TPI; however it should be appreciated that other thread pitches may be used.

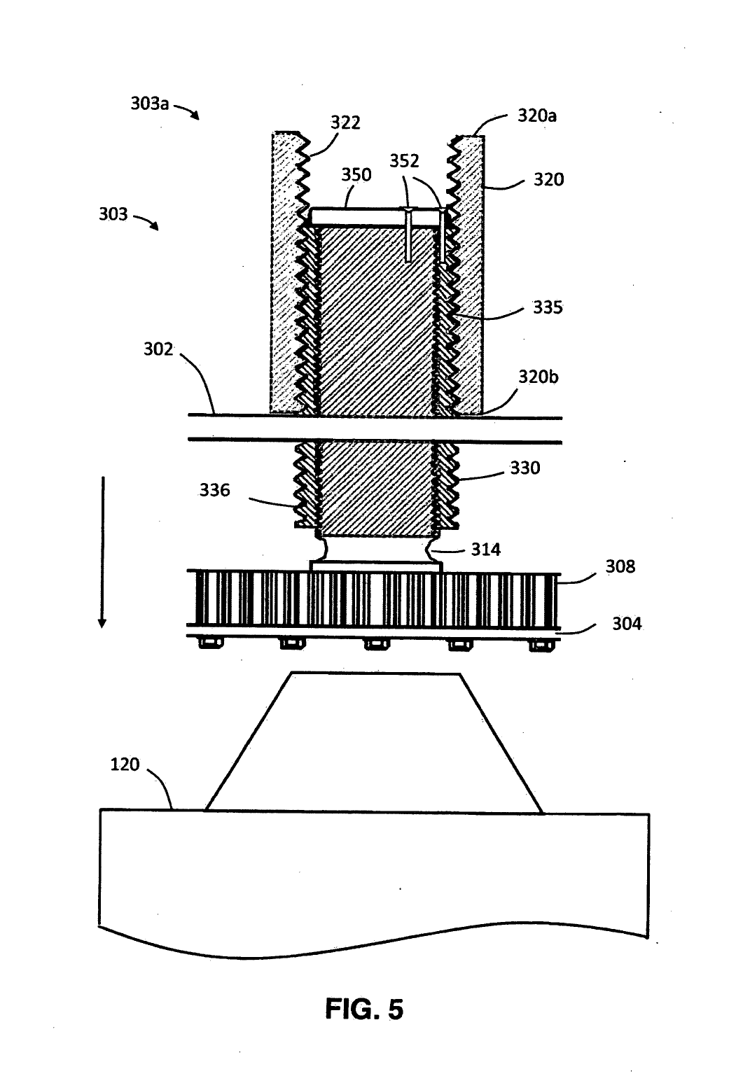

Referring now to FIG. 5, the lowering mechanism 303a also includes a nut 320 having a first end 320a and an oppositely disposed second end 320b. The nut 320 is secured to the reference surface 302 to prevent the nut from rotating relative to the reference surface and to prevent it from moving axially relative thereto. In the example embodiment described herein, the second end 320b of the nut 320 is welded to the reference surface 302; though it should be appreciated that the nut may be secured to surface 302 in other manners.

In an alternate embodiment, surface 302 may include a top member as shown as 302 and a plurality of biasing members attached to a lower face of surface 302. The biasing members may be attached at a lower end to a second surface located between surface 302 and surface 302b as shown in FIG. 5. In one embodiment, the biasing members may be springs.

The nut 320 includes an internally threaded cylindrical surface 322 having a second thread pitch. In the example embodiment described herein, the second thread pitch is 2 TPI; though it should be appreciated that it can be other thread pitches, different than the first thread pitch.

Referring now to FIGS. 4 and 5, the lowering mechanism 303a also includes an intermediate cylindrical member 330 disposed between the screw 314 and the nut 320 such that the screw, intermediate member and nut are coaxially aligned about the axis B (shown in FIG. 3). The intermediate member 330 includes a radially inner threaded surface 332 (shown in FIG. 4) having the first thread pitch, 4 TPI in this example. The threaded surface 332 is adapted to cooperate with the threaded surface 316 of the screw 314 in the form of a first threaded interface 333 having the first thread pitch. Examples of suitable first thread pitches can range from about two (2) to about eight (8) threads per inch, corresponding to the thread pitch of the threaded connectors of a first electrode and column the device 200 can accommodate. The intermediate member 330 also includes a radially outer threaded surface 336 (shown in FIG. 5) having the second thread pitch, 2 TPI in this example. The threaded surface 336 is adapted to cooperate with the threaded surface 322 of the nut 320 along a second threaded interface 335 having the second thread pitch. Examples of suitable pitches for the second thread pitch can range from about two (2) to about eight (8) threads per inch, corresponding to the thread pitch of the threaded connectors of a second electrode and column the device can accommodate. The second thread pitch being different than the first thread pitch.

As shown in FIG. 4, the lowering mechanism 303a also includes a first retaining element 340 for securing the intermediate member 330 to the nut 320. In the example provided, the first retaining element is an annular member 340 which can be formed of steel or other hard material.

The annular member 340 is removably fastened to a first end 330a of the intermediate member and the first end of the nut 320a, using fasteners 342 such as bolts, screws or the like. When installed, the annular member 340 secures the intermediate element 330 to the nut 320 to prevent them from rotating relative to each other and to prevent relative axial movement therebetween. The annular member 340, enables the screw 314 to rotate relative to the intermediate member 330 (and the nut 320 secured thereto), providing axial movement of the screw (and drum 304 connected thereto) along the first threaded interface 333 of the first thread pitch.

During electrode addition, rotation of the drum 304 by the motor 312 moves the drum and the electrode 130 axially relative to the reference surface 302 of the device 200 an amount commensurate with the first thread pitch. In this example, each 360 degree rotation of the drum moves the electrode downward towards the electrode column ¼ inch in accordance with the first thread pitch of 4 TPI. Using the first retaining element 340 in this manner enables the device 200 to add an electrode, such as for example the AGX® electrode 100, having threaded connectors of the first thread pitch, such as for example 4 TPI, to an electrode column 104a of similar thread pitch.

As shown in FIG. 5, the lowering mechanism 303a includes a second retaining element 350 for securing the intermediate element 330 to the screw 314. In the example embodiment described herein, the second retaining element is a circular disc-shaped member 350 which can be formed of steel or other hard material.

The disc-shaped member 350 is removably fastened to a first end 330a (shown in FIG. 4) of the intermediate member 330 and the first end 314a of the screw 314, using fasteners 352 such as bolts, screws or the like. When installed, the disc-shaped member 350 secures the intermediate element 330 to the screw 314 to prevent them from rotating relative to each other and to prevent relative axial movement therebetween. Use of the disc-shaped member 350 in this manner, enables the screw 314 (and captured intermediate element 330) to rotate relative to the nut 320, providing axial movement of the screw (and drum 304 connected thereto) along the second threaded interface 335 of the second thread pitch.

During electrode addition, rotation of the drum 304 by the motor 312 moves the drum and the electrode 130 axially downwards, relative to the reference surface 302 of the device 200, an amount commensurate with the second thread pitch. In this example, each 360 degree rotation of the drum moves the electrode downward towards the electrode column ½ inch. Using the second retaining element 350 in this manner enables the device 200 to add an electrode, such as for example the Apollo™ pinless electrode 120, having threaded connectors of the second thread pitch, such as for example 2 TPI, to an electrode column 104b of similar thread pitch.

In an embodiment, the removable first 340 and second 350 retaining members are easy to install and remove using the removable fasteners 342, 352 respectively, enabling the engagement mechanism 303 to be converted from a first electrode pitch to a second electrode pitch in less than an hour. In one embodiment only one retaining member 340 or 350 will be used at a time.

The threads of the electrode on the column 104, if left open to the atmosphere, may become dusty or susceptible to debris or other matter in the atmosphere. During periods of high humidity, the dust may form a paste or muddy type substance which can inhibit securing the new electrode 130 to the column 104. The air compressor 250 can be used to blow the dust from the electrode column threads 108 or 124. Alternatively, and especially in the case of a column having the male tang 124, a cover or shroud can be used to conceal the tang from the steel furnace ambient conditions, after adding the new electrode 130. The cover can have round metal top and heat resistant ceramic sides. In this embodiment a magnet system (not shown) may be installed on the robot 200 to remove the cover prior to adding the new electrode 130 to the column 104.

In one embodiment, prior to loading an electrode into device 200 the gripping mechanism 208 is unlocked and upper portion 202 for gripping the electrode is also unlocked and both are in position for receiving an electrode. Preferably the electrode to be received is standing in a vertical position. In one particular embodiment a spring loaded support grips of portion 202 grips the electrode.

In this embodiment, device 200 is lowered onto the electrode. The upper portion grips the electrode. Lowering mechanism 303a is set for the TPI associated with the engagement element of the electrode which will engage the electrode column. A crane is used to lift device 200 and the electrode to above the electrode column. Once the device 200 is above the column, lower portion 204 is lowered onto the column. Leveling knives 206 are employed and the lower portion 204 is aligned with the vertical axis of the electrode column. Once the lower portion 204 is aligned with the column, gripping mechanism 208 may engage the column. Next, upper portion 202 is lowered such that upper portion 202 rests on the rest of device 200. Then, leveling knives 206 and the spring loaded supports are retracted and the lowering mechanism 303a lowers the electrode toward the column and rotates the electrode to secure the electrode to the column. Once the electrode is secured to the column at a predetermined torque, upper portion 202 releases the electrode and gripping mechanism 208 releases the column.

In one instance, the above embodiments of the device may be used to add an electrode to the electrode column in less than ten (10) minutes from the time that the electrode has been deployed into the device, preferably five (5) minutes or less, more preferably four (4) minutes or less, and even more preferably two (2) minutes or less.

It will be appreciated that various aspects of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A device for adding a graphite electrode having threaded connectors for connecting the electrode to complimentary threaded connectors on an electrode column comprising an adaptable engagement mechanism for adding different electrodes having threaded connectors of different thread pitches.

2. The device defined in claim 1 wherein the device is an electrode robot.

3. The device defined in claim 1 wherein one of the different thread pitches includes a thread pitch of 4 threads per inch.

4. The device defined in claim 1 wherein one of the different thread pitches includes a thread pitch of 2 threads per inch.

5. The device defined in claim 1 wherein the different thread pitches includes thread pitches of 2 threads per inch and 4 threads per inch.

6. The device defined in claim 1 wherein one of the different thread pitches includes a thread pitch of 3 threads per inch.

7. The device defined in claim 1 wherein one of the different thread pitches includes a thread pitch of at least one of 5 threads per inch, 6 threads per inch, 7 threads per inch, 8 threads per inch, and combinations thereof.

8. The device defined in claim 1 wherein the electrodes have lengths between 2000 mm and 4000 mm.

9. The device defined in claim 8 wherein the electrodes have lengths between 2900 mm and 3700 mm.

10. The device defined in claim 9 wherein the electrodes have lengths between 2900 mm and 3400 mm.

11-16. (canceled)

17. The device defined in claim 1 further comprising a rotating mechanism for rotating the new electrode relative to the electrode column during addition of the new electrode to the electrode column.

18. The device defined in claim 17 wherein the engagement mechanism includes the rotating mechanism.

19. The device defined in claim 1 further comprising a gripping mechanism for gripping the electrode during adaptation of the electrode to the electrode column.

20. The device defined in claim 19 wherein the engagement mechanism includes the gripping mechanism.

21. The device defined in claim 1 capable to add both a pinless electrode and a pin electrode.

22. The device defined in claim 1 capable to accommodate electrodes of more than one diameter.

23. The device defined in claim 1 wherein the electrode has a nominal length of more than 2700 mm.
